(19) United States
(12) Patent Application Publication
(10) Pub. No.: US 2023/0349592 A1
(43) Pub. Date: Nov. 2, 2023

(54) ELECTRIC ROOFING TORCH

(71) Applicant: IMPERIAL THERMAL ENGINEERING LTD, Essex (GB)

(72) Inventor: Jonathan FORBES-BROWN, Essex (GB)

(21) Appl. No.: 17/800,695

(22) PCT Filed: Feb. 18, 2021
(86) PCT No.: PCT/GB2021/050401

§ 371 Date: Aug. 18, 2022

(30) Foreign Application Priority Data
Feb. 18, 2020 (GB) 2002224.0

(51) Int. Cl. F24H 3/04; F24H 9/00; H05B 3/42; F04D 25/06; F04D 29/32; E04D 15/06

(52) U.S. Cl. CPC F24H 3/0423; F24H 9/0073; H05B 3/42; F04D 25/06; F04D 29/325; E04D 15/06; H05B 2203/022; E04D 5/149

(57) ABSTRACT

An electric roofing torch comprising a tubular body having an upstream end and a downstream end, a fan unit mounted in the tubular body to drive a flow of air through the tubular body and a heater tube comprising a heater matrix, the heater tube being mounted in the tubular body to heat the flow of air as it passes through the tubular body. The fan unit comprises an electric vaneaxial fan which is mounted upstream of the heater tube. The fan unit is mounted in the tubular body to drive a flow of air through the tubular body at velocity, pressure and volume that is sufficient for roofing operations such as laying roofing membranes, with zero carbon emissions. There is also provided a method of providing a working flow of hot air from the electric roofing torch for such a roofing operation.

### FIELD

The present specification concerns electric roofing torches.

### BACKGROUND

Roofing products, such as bitumen, are used in the sealing of roof structures. During the application of roofing membranes, bitumen-based products are melted using gas-powered roofing torches, and these are used in order to seal the membranes to the roof structure. Prior to applying the membrane, the torch may be used to prepare the area by drying the surface where the membrane is to be laid and/or to ready the membrane.

These gas-powered roofing torches come in many forms, but are generally in the form of a hand-held device comprising a lance with a nozzle at the end. The lance is coupled to a gas source, for example, a cylinder of propane or butane. The gas is burnt at the nozzle to produce a hot naked flame and generate heat, which is then used to melt the bitumen-based roofing product and/or prepare the surface beforehand. The bitumen-based materials might be incorporated into a roofing membrane or they might be heated and applied separately during sealing of a membrane.

However, the use of naked flames during the construction or repair of a building poses a tremendous fire risk and there is plenty of evidence of instances where a fire has started through the use of a naked flame from such a roofing torch. It is not only the presence of flammable gases but in such construction environments there will usually be exposed, combustible parts of the roof structure as well as combustible debris collected in the working area. In addition to safety, there are also moves to burn fewer fossil-based resources.

As a result, it would be desirable to provide an improved roofing torch, particularly one which avoids the use of a naked flame and reduces carbon consumption.

There have been a number of developments recently with electric powered roofing torches. In one known example, a backpack is provided comprising an electric fan to generate a flow of air which is directed via a flexible tube into a handheld torch provided with an electric heater matrix to heat the air. The resulting flow of hot air is then directed via a lance or nozzle to where it is needed in order to apply heat to a roofing product, e.g., a roofing membrane being used on a roof structure. This electric roofing torch solution, while offering many benefits through avoiding naked flames and reduced carbon consumption, is however quite bulky and heavy for the operator to manoeuvre, and improvements in performance are also desirable.

### SUMMARY

According to one aspect, there is provided an electric roofing torch comprising a tubular body having an upstream end and a downstream end, a fan unit mounted in the tubular body to drive a flow of air through the tubular body and a heater tube comprising a heater matrix, the heater tube being mounted in the tubular body to heat the flow of air as it passes through the tubular body. The fan unit comprises an electric vaneaxial fan which is mounted upstream of the heater tube.

Thus the fan unit is mounted in the tubular body to drive a flow of air through the tubular body at velocity, pressure and volume that is sufficient for roofing operations.

The collection of features provided by at least the preferred embodiments work together to result in an electric roofing torch that is:
(i) lightweight to use,
(ii) easy to manoeuvre during roofing operations,
(iii) is free of naked flames,
(iv) does not use flammable products, and/or
(v) is able to produce the heat, volume and flow of air required for the roofing operations, such as laying roofing membranes, with zero carbon emissions.

For example, the heater tube may be capable of heating the flow of air to temperatures in excess of 500° C., more preferably in excess of 600° C. The heater tube may comprise a complex matrix ‘super heater’ that is mounted in the tubular body to heat the flow of air as it passes through the tubular body.

The fan unit may be able to generate volumes of air flow from a nozzle of the electric roofing torch that are in excess of 800 m³/h, more preferably in excess of 900 m³/h. This may be with speeds of air flow in excess of 80 km/h or even more than 90 km/h. In a preferred embodiment, air flow speeds of greater than 100 km/h, for example, 105 km/h or greater, are achievable from the electric roofing torch at such volumes.

The fan unit may be a high frequency, three-phase AC, electric vaneaxial fan.

Through a selective choice of materials and construction, it is possible to provide a lightweight solution for an operator. Thus in preferred embodiments it may be possible to keep the overall weight of the electric roofing torch down to just a few kilograms (e.g., less than 7 kg and preferably less than 5 kg) through an appropriate choice of components. For example, the fan unit may have a weight of less than 2.5 kg. The tubular body may weigh less than 2 kg, preferably less than 1.5 kg, and more preferably still less than 1.0 kg. Any part where weight can be minimised will help to reduce the weight that the operator has to carry for potentially extended periods, as well as helping to improve the torch's general usability.

The fan unit may comprise an impeller that has a plurality of blades. The blades may each comprise a leading edge and a trailing edge, and wherein the trailing edges of the blades may have been machined back to provide a cylindrical cut-away profile. For example, the trailing edge of each blade comprises a radially outer, rectangular cut-away portion and a radially inner, extended rib portion that blends to a domed outer surface of a hub of the impeller. Such a configuration, helps to facilitate the generation of a powerful flow of air when the impeller is rotated at high rotational speeds.

Within the fan unit, downstream of the impeller there are a plurality of vanes. There between 5 and 15 vanes, for example, extending between a radially inner surface and a radially outer surface of a core flow path. These help to pressurise the flow of air.

The tubular body may comprise a double-walled structure comprising an inner tube and an outer tube, the inner tube housing the heater tube and providing a conduit for the flow of air between an upstream end of the inner tube and a downstream end of the inner tube. In this way the operator can be shielded from the heat of the heater tube located within the inner tube. A downstream end of the fan unit may also support an upstream end of the inner tube within the outer tube, facilitating construction.

According to another aspect, there is provided a method of providing a working flow of hot air from an electric roofing torch for a roofing operation using comprising generating a flow of air within a tubular body of an electric roofing torch, heating the flow of air using an electric heater matrix mounted in the tubular body of the electric roofing torch to heat the flow of air as it passes through the tubular body from an upstream end to a downstream end of the tubular body, wherein the flow of air through the electric roofing torch is generated by an electric vaneaxial fan which is mounted upstream of the heater tube.

The method of providing a working flow of hot air may comprise using an electric roofing torch as described herein in relation to the first aspect.

### FIGURES

Certain preferred embodiments will now be described in greater detail, by way of example only, and with reference to the accompanying drawings, in which:

FIG. 1 shows a perspective view of an exemplary electric roofing torch (with the carriage removed);

FIG. 2 shows an end on view looking into the outlet nozzle of the electric roofing torch of FIG. 1;

FIG. 3 shows a cross-sectional view through the electric roofing torch of FIG. 1 taken along the central axis A-A;

FIG. 4 shows a perspective view of an exemplary fan housing for the fan unit;

FIG. 5 shows a cross-sectional view of the fan housing of FIG. 4;

FIG. 6 shows a cross-sectional view of an exemplary fan unit;

FIG. 7 shows a cross-sectional view of an exemplary fan core for the fan unit of FIG. 6;

FIG. 8 shows a cross-sectional view of an exemplary fan core comprising a fan stator and an impeller;

FIG. 9A shows a perspective view of an upstream side of an exemplary impeller and FIG. 9B shows a perspective view of a downstream side of the exemplary impeller;

FIG. 10 shows a perspective view of an exemplary electric roofing torch;

FIG. 11 shows an end on perspective view of the electric roofing torch of FIG. 10 looking towards the outlet nozzle;

FIG. 12 shows an exemplary power unit for use with the electric roofing torch of FIG. 10;

FIG. 13 shows a perspective view of an exemplary delivery nozzle;

FIG. 14 shows an end on view of the delivery nozzle of FIG. 13 looking towards the outlet; and

FIG. 15 shows an exploded perspective view of the electric roofing torch of FIG. 3.

### DETAILED DESCRIPTION

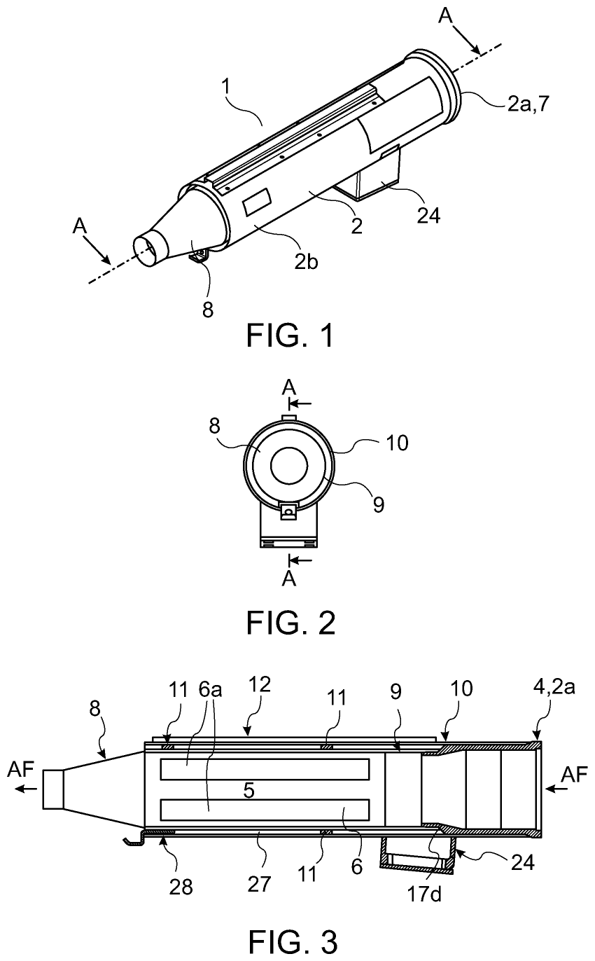

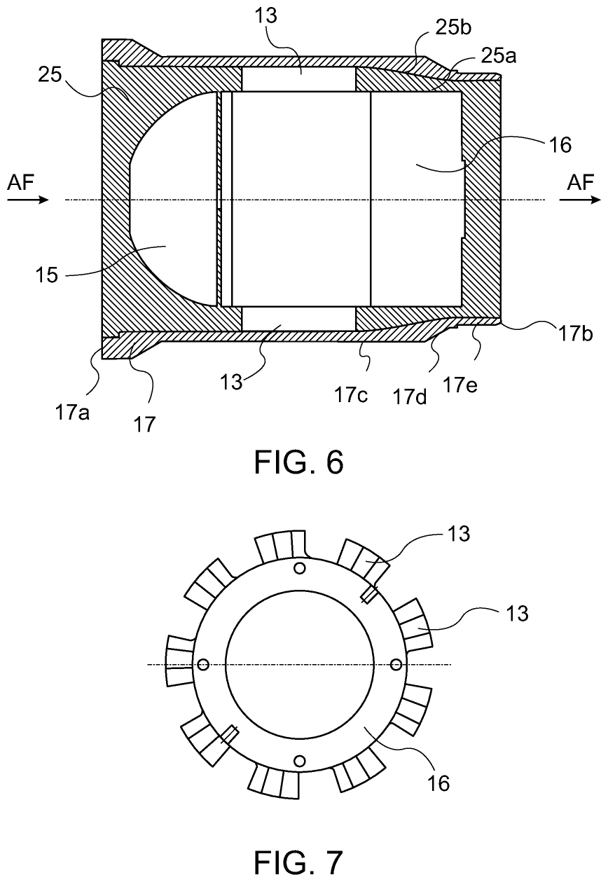

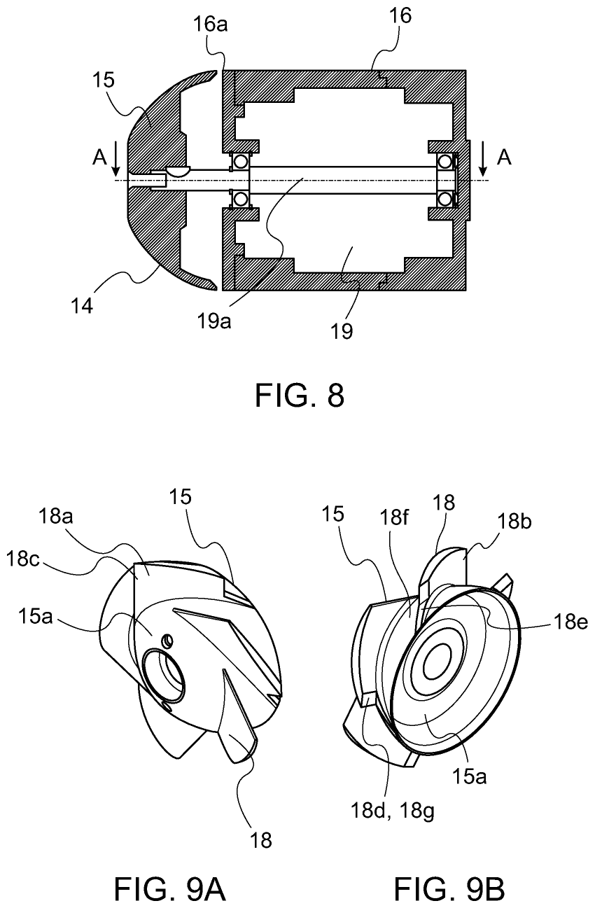

As shown in FIG. 1, an electric roofing torch 1 is provided comprising a tubular body 2 having an upstream end 2a and a downstream end 2b. FIG. 2 is an end-on view looking up towards the downstream end 2b of the tubular body 2, and FIG. 3 is a side cross-sectional view taken along the central axis A-A. As seen from FIG. 3, a fan unit 4 is mounted in the upstream end 2a of the tubular body 2 to drive a flow of air through the tubular body 2. A heater tube 5 is provided within the tubular body 2 comprising a heater matrix 6. The heater tube 5 is mounted in the tubular body 2 to heat the flow of air as it passes through the tubular body 2. In accordance with the present invention, the fan unit 4, which is now mounted within the tubular body 2, comprises an electric vaneaxial fan (see FIG. 6) which is mounted upstream of the heater tube 5.

As shown in FIG. 1, an inlet 7 of the tubular body 2 may be provided at a first, upstream end 2a thereof and an outlet 8 provided at a second, downstream end 2b thereof opposite the first end. The tubular body 2 is arranged to guide air from the fan unit 4 through the heater tube 5 towards the outlet 8. The outlet 8 is preferably in the form of a nozzle outlet, in particular a conical nozzle 8.

The tubular body 2 may have a circular cross-section. The tubular body 2 may take the form of a cylindrical housing and is preferably straight in order to aid fabrication.

The tubular body 2 may comprise a double-walled structure as shown, comprising an inner tube 9 and an outer tube 10. The inner tube 9 and outer tube 10 are arranged as concentric tubes. The inner tube 9 may comprise mica and carbon fibre. The inner tube 9 may provide a dual function of housing the heater tube 5 and providing a conduit for the flow of air between an upstream end 2a of the inner tube 9 and a downstream end 2b of the inner tube 9. The outer tube 10 may provide a housing for the electric roofing torch 1, the housing being configured to shield an operator from heat from the heater tube 5 during use.

The outer tube 10 may be longer than the inner tube 9. In this way, the fan unit 4 can be located within an upstream end 2a, 7 of the outer tube 10, in a region extending between the upstream end of the outer tube 10 and an upstream end of the inner tube 9. A downstream end of the fan unit 4 may support the upstream end of the inner tube 9 within the outer tube 10.

The tubular body 2 may comprise a plurality of spacers 11, preferably annular or ring-shaped spacers 11, arranged between an outer surface of the inner tube 9 and an inner surface of the outer tube 10. There may be two spacers, for example, as shown in FIG. 3.

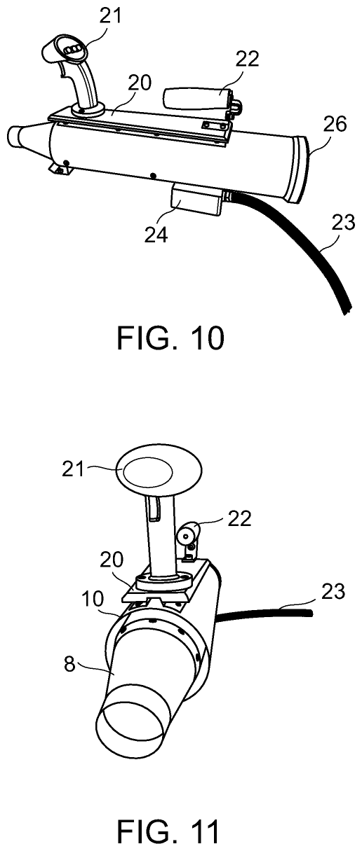

A mount 12, for example, in the form of a track, may be provided on an upper surface of the outer tube 10. A carriage 20 may be fitted to the mount 12 as shown in FIG. 10. The carriage may be provided with a set of controls 21, for example, in the form of a joystick or throttle through which the operator can carry and operate the torch with one hand. A handle 22 may be provided for the operator's other hand, such that the torch is carried in both hands. Other ways of carrying the electric roofing torch and/or controlling the operation of the torch are also possible, for example, a sling that the operator can rest on an operator's arm to transfer the weight of the torch.

Also visible in FIG. 10 is flexible power lead 23, and a junction box 24 for where the power comes into the electric roofing torch 1. A high power electrical supply may be connected to the electric roofing torch 1, for example a 240V AC and 32 A supply. The junction box 24 may house electronics for operating the electrical components like the fan unit 4 and the heater tube 5. The electronics may raise the frequency of an electrical supply to the fan unit 4.

The fan unit 4 is shown in more detail in FIG. 6. It comprises a fan core 14 comprising an impeller 15 and a stator core 16, which are housed within a fan housing 17. The fan housing 17 has an upstream end 17a and a downstream end 17b. The impeller 15 is arranged at an upstream edge 16a of the stator core 16, with the impeller 15 being arranged to rotate about a central axis A-A of the fan unit 4. A motor 19 is housed within the stator core 16, the motor having a drive shaft 19a for providing rotational drive to the impeller 15.

The impeller 15 may be provided with a plurality of aerodynamically profiled blades 18, for example, as shown in FIGS. 9A and 9B. There may be between 3 and 8 blades 18, more preferably five blades 18 as shown, the blades 18 extending radially outward from a hub 15a of the impeller 15.

As the fan unit 4 is a vaneaxial fan, the impeller 15 is arranged upstream of a plurality of vanes 13. These vanes 13 extend radially, between a radially inner surface 25a and a radially outer surface 25b of a core flow path 25 defined within the fan unit 4.

The radially outer surface 25b of the core flow path 25 is provided by an internal surface of a fan housing 17. The radially inner surface 25a is provided by an outer surface of the fan core 14.

There may be between 5 and 15 vanes 13 extending between the radially inner surface 25a and the radially outer surface 25b of the core flow path 25. Preferably there are between 7 and 12 vanes and most preferably there are 9 vanes. The vanes may be spaced equally around the cylindrical surface of the stator core 16

The vanes 18 may be integrally formed with the fan core 16 and/or the fan housing 17. In the example of FIG. 7, the vanes 18 are provided integrally on the cylindrical outer surface of the stator core 16, these vanes 13 extending therefrom to slot into position within and against the inner surface 25b of the fan housing 17, in this way suspending the fan core 14 within the fan unit 4 in a concentric fashion.

The electrical motor 19 may be one that is designed, under normal operation, to rotate the impeller 15 at speeds in excess of 15,000 rpm, more preferably in excess of 20,000 rpm or even 22,000 rpm. In one example the motor 19 is arranged to rotate the impeller 15 at 24,000 rpm or higher. The rotational speed of the impeller 15 during use may be controllable by the operator, e.g., by using the controls 21.

The impeller 15 may comprise a domed hub 15a, from which the blades 18 extend. The impeller 15 may have an external contour that blends with that of the stator core 16.

The impeller 15 may be fabricated through being printed using a 3D printing tool. The 3D printing may form an internal lattice framework within the impeller 15 to minimise weight, in particular rotational weight.

Alternatively or additionally, the impeller 15 may be machined to final form, for example, from a cylindrical block of material or from a cast blank which is partially pre-formed to an impeller shape.

In one embodiment, the impeller 15 is made from aluminium extruded stock (for example, 6082-T6) which has been milled to final form. In another, the impeller 15 is 3D printed in either aluminium or titanium. Other materials and methods of fabrication are also envisaged.

The blades 18 each comprise a leading edge 18c and a trailing edge 18d. The trailing edges 18d of the blades 18 may have been machined back to provide a cylindrical cut-away profile. The trailing edge 18d of each blade 18 may comprise a radially outer, rectangular cut-away portion and a radially inner, extended rib portion 18e that blends to the domed outer surface 18f of the hub 18a. The trailing edge 18d of such a cut-away portion may be provided by a flat, circumferentially extending trailing surface 18g that extends between the suction and pressure surfaces 18a,18b of the blade 18.

The stator core 16 may comprise a range of materials. For example, it may comprise a polymer-based material, a carbon rich nylon or other composite material comprising a polymer-based matrix material, for example, a polyester or epoxy based material. The stator core 16 could also be machined from a lightweight metal such as an aluminium alloy.

The fan unit 4, the heater tube 5 and the tubular body 2 share a common axis. The fan unit 4 is housed within the tubular body 2, in particular an inner tube 9 of a dual-walled tubular body 2.

The fan housing 17 provides a fan inlet (upstream end 17a) which protrudes axially beyond the upstream end 2a of an outer tube 10 of the tubular body 2 and a fan outlet (downstream end 17b) that is arranged within the inner tube 9 of the tubular body 2, upstream of the heater tube 5.

The fan unit 4 may be provided with a grille 26 at the fan inlet 17a (see FIG. 10). The grille 26 may be configured to prevent clothing or fingers of the operator from entering the fan unit 4 of the electric roofing torch 1, while providing openings that allow a sufficient air flow into the torch 1.

The fan housing 17 may comprise a machined sleeve. The sleeve may have been machined from a material like aluminium (for example, hollow stock 6082-T6), or it could be made from a polymer-based material, e.g., nylon or a polymer-based matrix material which is reinforced with fibres. In one example this might be a carbon-rich nylon mix. In preference to machining, the fan housing 17 may be 3D printed. Whatever the materials, they are preferably chosen to help minimise the overall weight of the electric roofing torch 1.

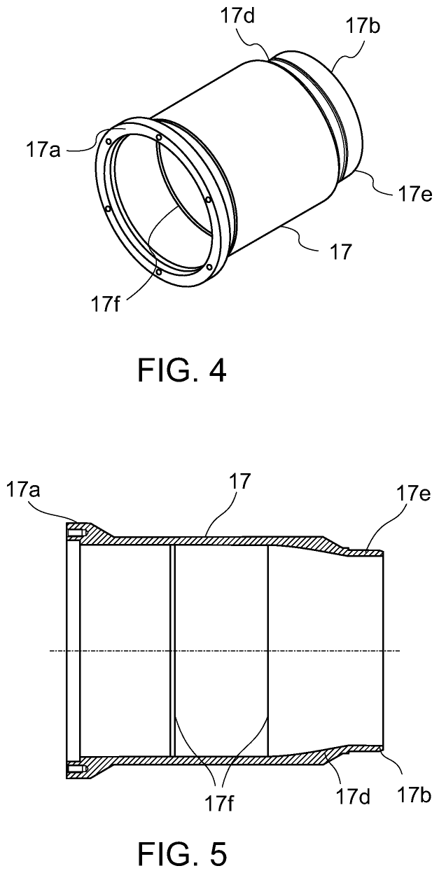

The inner surface 25b of the fan housing 17 may comprise an axially staged profile (see FIGS. 4 and 5). In this way a radius of the inner surface 25b may reduce from the upstream end 17a to the downstream end 17b in a stepwise profile, the steps 17f corresponding in position to the edges of the vanes 13. For example, a step 17f may be provided in the inner surface 17b to locate the vanes 13 in position during assembly when the stator core 16 is introduced into the fan housing 17 from an upstream end 17a of the fan housing 17. The steps 17f may help to locate the stator core 16 within the fan housing 17 through the engagement of the vanes 13. This is not just during fabrication but also during use when large forces are generated in reaction to the force imparted to the air flow.

The outer surface 17c of the fan housing 17 may comprise a bridging section 17d at a downstream end 17b. The bridging section 17d may bridge across an annular space 27 between the outer tube 10 and the inner tube 9 of the tubular body 2. The bridging section 17d may have an outer diameter dimension that reduces in a downstream, axial direction to bridge from the outer tube 10 to the inner tube 9 of the tubular body 2 (see FIG. 3). The outer surface 17c may comprise an annular seat 17e of reduced diameter at the downstream end 17b for seating within an inner tube 9 of the tubular body 2.

The inner tube 9 of the tubular body 2 may be provided with a nozzle cone 8, for example, as a separate component that is fitted to the inner tube 9, at the downstream end of the inner tube 9 for concentrating the flow of air as it exits the heater tube 5. The nozzle cone 8 may comprise stainless steel or other suitable heat resistant material.

The inner tube 9 may comprise a polymer-based material. It may comprise, for example, a polymer-based matrix material which is reinforced with fibres, e.g., carbon fibres. The polymer-based matrix material may comprise a polyester or epoxy based material.

The outer tube 10 may comprise a polymer-based material. It may comprise, for example, a polymer-based matrix material which is reinforced with fibres, e.g., carbon fibres. The polymer-based matrix material may comprise a polyester or epoxy based material.

The materials of the inner tube 9 and outer tube 10 are chosen to withstand the operating temperatures of the electric roofing torch 1 while minimising overall weight as far as possible.

The heater tube 5 may comprise a plurality of electric heater elements 6a. These may be arranged in the form of a matrix 6 that the air is passed through to heat the air enroute to a nozzle 8 of the electric roofing torch 1.

The heater tube 5 may consume more than 18 kW during use, preferably more than 20 kW, and more preferably still around 22 kW or more during use.

The heater tube 5 may comprise a housing provided by a mica cylindrical tube. This may be configured to fit within an inner tube 9 of the tubular body 2. The mica will help to insulate the inner tube 9 from the high operating temperatures. The heater elements 6a of the heater tube 5 may be supported on a mica chassis in a ‘complex’ formation and arranged to provide a corresponding resistance which when subjected to an electrical load, creates the heat output from the electric roofing torch 1.

The complex formation of the heater elements 6a and the matrix 6 (‘super heater’) may take the form of a set of resistance circuits arranged to provide as uniform as possible heat across the chassis which fills the inner tube 9. There may be three or more resistance circuits. More preferably there are six resistance circuits. In such a set-up, pairs of resistance circuits may be coupled to each phase of a three phase supply. The resistance circuits may be arranged in a hexagonal array within the heater matrix 6 to provide a uniform heat across the heater tube 5. The air is forced through the complex matrix super heater 6 and when the resistance wires are subjected to an electrical load, thermal energy is transferred from the resistance wires into the air. This process is further accelerated because the flow of air within the electric roofing torch 1 is restricted at an exit point via a nozzle 8, for example, a conical nozzle 8.

The fan unit 4, as a result of being a vaneaxial fan, may be able to generate volumes of air flow from a nozzle 8 of the electric roofing torch 1 that are in excess of 800 m³/h, more preferably in excess of 900 m³/h. This may be with speeds of air flow in excess of 80 km/h or even more than 90 km/h. In a preferred embodiment, air flow speeds of greater than 100 km/h, for example, 105 km/h or greater, are achievable from the electric roofing torch 1 at such volumes. The heater tube 5 may be capable of heating the flow of air to temperatures in excess of 500° C., more preferably in excess of 600° C. The electric roofing torch 1 may also have a total weight of less than 5 kg, preferably less than 3 kg, and a size of around half a metre, making it easy for an operator to manoeuvre.

The electric roofing torch 1 may further comprise a hanging bracket 28 provided on an underside of the electric roofing torch 1. The hanging bracket 28 may be configured to provide a foot for when the electric roofing torch 1 rests on the ground between roofing operations.

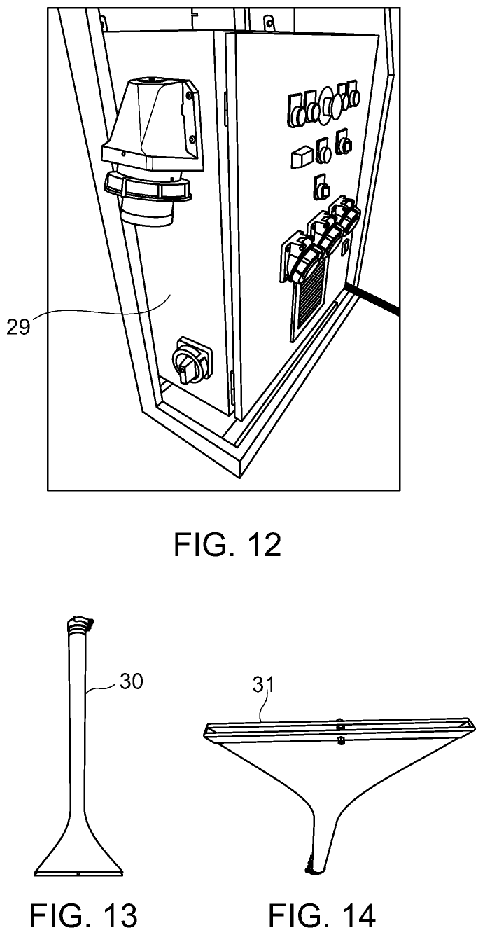

The electric roofing torch 1 may operate on a three-phase AC mains supply. Alternatively power can be generated using a mobile generator 29 such as that shown in FIG. 12. The electric roofing torch 1 may have a power rating of 22.5 kW or more, drawing a current of about 32 amps.

The electric roofing torch may also comprise a lance or delivery nozzle 30, e.g., as shown in FIGS. 13 to 14. The lance or delivery nozzle may be mountable on a nozzle outlet 8 provided at the downstream end 2b of the inner tube 9 in order to direct hot air from the nozzle outlet 8 of the tubular body 2 for use in a roofing operation. The lance or delivery nozzle 30 may extend a distance from the operator's hips to a floor level. Thus, the torch lance or delivery nozzle 30 may configured to reach the floor level when the electric roofing torch is in use, and preferably when the electric roofing torch 1 is being carried by a standing operator.

The lance or delivery nozzle 30 may be made of a lightweight material such as aluminium, or more preferably a composite material such as a carbon reinforced matrix material, e.g., as shown in FIGS. 13 and 14, that is able to withstand the high operating temperatures. The composite material may be shaped to define a blade-shaped aperture 31 to provide a wide flat jet of hot air for use in the roofing operation.

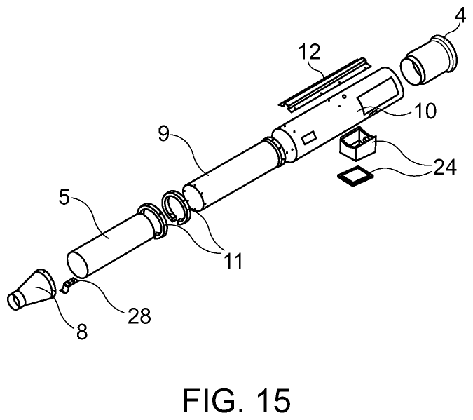

FIG. 15 shows an exploded, perspective view of the electric roofing torch shown in FIG. 3 to help aid understanding.

There follows a brief discussion of the preferred (non-limiting) dimensions for the main components of the electric roofing torch, such as the fan unit, the tubular body, etc.

Exemplary Dimensions for the main components:

(i) Fan Unit

The impeller may comprise an outer diameter with the blades 18 included of more than 100 mm, preferably more than 105 mm. In one example, the outer diameter of the impeller is 109 mm or more.

The hub 15a of the impeller 15 may have a maximum outer diameter of more than 80 mm. In a preferred embodiment the hub 15a of the impeller 15 has a maximum outer diameter of more than 85 mm, more preferably 88 or 89 mm.

The blades 18 of the impeller 15 each comprise a suction surface 18a and a pressure surface 18b. The suction surface 18a may be profiled with a radius (e.g., when viewed perpendicular to the fan axis) of between 80 and 100 mm at a mid-chord position. The suction surface 18a may comprise a radius of between 25 and 40 mm at a leading edge thereof. The pressure surface 18b may be profiled with a radius (e.g., when viewed perpendicular to the fan axis) of between 200 and 250 mm at a mid-chord position. The pressure surface 18b may comprise a radius of between 30 and 45 mm at a leading edge thereof.

Where the blades 18 of the impeller 15 may have been machined back to provide a cylindrical cut-away profile, the trailing edges 18d of the blades 18 may have been machined back by more than 5 mm, more preferably by more than 7 mm. In one example, they have been machined back to provide a cut-away of 10 mm. The trailing edge 18d of each blade 18 may comprise a radially outer, rectangular cut-away portion and a radially inner, extended rib portion 18e that blends to the domed outer surface 18f of the hub 15a. The leading edge 18c of each blade 18 may be set back from a nose of the hub 15a. This may be by more than 5 mm, more preferably by more than 8 mm, and more preferably still by 11 mm.

The radially inner surface of the fan housing may comprise a diameter of greater than 100 mm at its upstream end. For example, it may comprise a diameter of greater than 105 mm, preferably 110 mm±2 mm. The radially inner surface of the fan housing may comprise a diameter of less than 105 mm at its downstream end. For example, it may comprise a diameter of less than 102 mm, preferably 98 mm±2 mm.

The radially outer surface 17c of the fan core 17 may have a diameter of greater than 80 mm. For example, it may have a diameter of greater than 85 mm, and more preferably it is 89 or 90 mm±2 mm.

An annular cross-sectional area of the core flow path 25 (defined between the radially inner surface 25a and the radially outer surface 25b in the radial direction) may decrease from the upstream end 17a of the fan housing 17 to the downstream end 17b of the fan housing 17. A radial separation of the radially inner surface 25a and the radially outer surface 25b of the core flow path 25 may be greater than 5 mm, for example, greater than 7 mm. The radial separation of the radially inner surface 25a and the radially outer surface 25b of the core flow path 25 may be less than 15 mm, for example, less than 12 mm. Preferably the radial separation is 10 mm±2 mm.

(ii) Tubular Body

The inner tube 9 may have an inner diameter greater than 100 mm, for example an inner diameter of 104 mm±2 mm. The inner tube 9 may have an outer diameter of less than 110 mm, for example, an outer diameter of 107 mm±2 mm.

The inner tube 9 may have a length of greater than 300 mm. The length of the inner tube 9 may be less than 500 mm. In a preferred embodiment the inner tube 9 has a length of 400 mm±5 cm.

The outer tube may have an inner diameter greater than 120 mm, for example, 122 mm±2 mm. The outer tube may have an outer diameter of less than 130 mm, for example, 125 mm±2 mm.

The outer tube 10 may have a length of greater than 400 mm. The length of the outer tube 10 may be less than 600 mm. In a preferred embodiment the outer tube 10 has a length of 525 mm±5 cm.

(iii) Delivery Nozzle

The delivery nozzle 30 may comprise a blade aperture 31 at a distal end thereof to create a thin (for example, less than 1 cm high) jet of hot air exiting from the delivery nozzle of the electric roofing torch during use, the thin jet of hot air spanning a width of greater than 150 mm.

1.-25. (canceled)

26. An electric roofing torch comprising:
a tubular body having an upstream end and a downstream end;
a fan unit mounted in the tubular body to drive a flow of air through the tubular body; and
a heater tube comprising a heater matrix, the heater tube being mounted in the tubular body to heat the flow of air as it passes through the tubular body,
wherein the fan unit comprises an electric vaneaxial fan which is mounted upstream of the heater tube.

27. The electric roofing torch as claimed in claim 26, wherein the electric vaneaxial fan is a three-phase fan unit and the motor is arranged to operate at rotational speeds in excess of more than 15,000 rpm.

28. The electric roofing torch as claimed in claim 26, wherein the fan unit comprises a fan housing and a fan core, the fan core comprising a stator core and an impeller, the impeller being arranged to rotate about a central axis of the electric roofing torch.

29. The electric roofing torch of claim 28, wherein the impeller is provided with a plurality of blades, the impeller being arranged upstream of a plurality of vanes, the plurality of vanes extending between a radially inner surface of the fan housing and a radially outer surface of the fan core.

30. The electric roofing torch of claim 29, wherein the stator core houses a motor for driving the impeller.

31. The electric roofing torch of claim 29, wherein the impeller blades each comprise a leading edge and a trailing edge, and
wherein the trailing edges of the blades have been machined back to provide a cylindrical cut-away profile.

32. The electric roofing torch as claimed in claim 26, wherein the tubular body comprises a double-walled structure comprising an inner tube and an outer tube, the inner tube housing the heater tube and providing a conduit for the flow of air between an upstream end of the inner tube and a downstream end of the inner tube.

33. The electric roofing torch as claimed in claim 32, wherein the outer tube provides a housing for the electric roofing torch, the housing being configured to shield an operator from heat from the heater tube during use.

34. The electric roofing torch as claimed in claim 32, wherein the inner tube is shorter than the outer tube and the fan unit is located within an upstream end of the outer tube extending between the upstream end of the outer tube and an upstream end of the inner tube.

35. The electric roofing torch as claimed in claim 32, wherein the heater tube is housed within the inner tube of the tubular body, the heater matrix comprising heater elements extending longitudinally within the heater tube and arranged to extend into the flow of air which passes through the electric roofing torch when in use.

36. The electric roofing torch as claimed in claim 32, wherein the fan housing provides a fan inlet which protrudes beyond the upstream end of the outer tube and a fan outlet that is arranged within the inner tube upstream of the heater tube.

37. The electric roofing torch as claimed in claim 32, wherein the outer surface of the fan housing comprises a bridging section at a downstream end, which bridges across an annular space between the outer tube and the inner tube of the tubular housing; the bridging section having an outer diameter dimension that reduces in a downstream, axial direction to bridge from the outer tube to the inner tube of the tubular housing.

38. The electric roofing torch as claimed in claim 37, wherein the outer surface of the fan housing comprises an annular seat of reduced diameter at the downstream end for seating within the inner tube of the tubular housing.

39. The electric roofing torch as claimed claim 32, wherein a downstream end of the fan unit supports the upstream end of the inner tube within the outer tube.

40. The electric roofing torch as claimed claim 26, wherein the heater tube comprises a tubular support for a plurality of electric heater elements,
wherein the plurality of electric heater elements comprises six resistance circuits and
wherein the plurality of electric heater elements are arranged in a hexagonal configuration when viewed axially.

41. The electric roofing torch as claimed claim 26, comprising a carriage mounted on an outer surface of the tubular body, the carriage providing a sling for carrying the electric roofing torch on an arm of an operator.

42. The electric roofing torch as claimed in claim 41, wherein the carriage comprises a control for the operator to control the temperature, volume and/or pressure of the flow to be delivered for the roofing operation.

43. The electric roofing torch as claimed in claim 26, further comprising a delivery nozzle fitted to a nozzle outlet provided on the downstream end of the tubular body to direct hot air from the nozzle outlet of the tubular body for use in a roofing application.

44. A method of providing a working flow of hot air from an electric roofing torch for a roofing operation using comprising:
generating a flow of air within a tubular body of an electric roofing torch, heating the flow of air using an electric heater matrix mounted in the tubular body of the electric roofing torch to heat the flow of air as it passes through the tubular body from an upstream end to a downstream end of the tubular body,
wherein the flow is generated by an electric vaneaxial fan which is mounted upstream of the heater tube.

45. An electric roofing torch comprising:
a tubular body having an upstream end and a downstream end;
a fan unit mounted in the tubular body to drive a flow of air through the tubular body; and
a heater tube comprising a heater matrix, the heater tube being mounted in the tubular body to heat the flow of air as it passes through the tubular body,
wherein the fan unit is an electric vaneaxial fan which is mounted upstream of the heater tube, that comprises a fan housing and a fan core, the fan core comprising a stator core and an impeller, the impeller being arranged to rotate about a central axis of the electric roofing torch;
wherein the tubular body comprises a double-walled structure comprising an inner tube and an outer tube, the inner tube housing the heater tube and providing a conduit for the flow of air between an upstream end of the inner tube and a downstream end of the inner tube; and
wherein the fan housing provides a fan inlet which protrudes beyond the upstream end of the outer tube and a fan outlet that is arranged within the inner tube upstream of the heater tube.
